(19) United States
(12) Patent Application Publication
(10) Pub. No.: US 2008/0002538 A1
(43) Pub. Date: Jan. 3, 2008

(54) System for Controlling the Temperature in Components

(75) Inventor: Jeroen Arnoldus Leonardus Johannes Raaymakers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,343

(22) PCT Filed: Jun. 14, 2005
(86) PCT No.: PCT/IB05/51957

§ 371 Date: Dec. 11, 2006

(30) Foreign Application Priority Data
Jun. 22, 2004 (EP) 04102859.8

(51) Int. Cl. G11B 7/00; G05D 23/19

(52) U.S. Cl. 369/44.32; 236/1 F; 369/44.25

(57) ABSTRACT

A system for controlling the temperature in an electrical component. The power dissipation of the electrical component is measured and compared to a desired power dissipation. In case the measured power dissipation differs from the desired power dissipation a signal, preferably a signal having an energy outside the region of normal operation of the electrical component, is injected into the electrical component in order to control the power dissipation and thereby the temperature of the electrical component. May also be used for controlling the temperature of another component positioned in the vicinity of the electrical component, e.g. an optical component, such as a lens. Advantageous because a separate temperature sensor is avoided. Suitable for use in an optical disk drive, in particular for blu-ray disks.

The present invention relates to a system for controlling the temperature in components, in particular electrical, optical or mechanical components. The system according to the invention is particularly suited for being applied in ‘accurate devices’ having a performance which is critically influenced by temperature, in particular optical disk drives, but also in e.g. linear motors in wafer steppers, other components in wafer steppers, milling machines, photo cameras or video cameras.

Generally components are specified to work properly for a certain temperature range. Nevertheless they are designed to have optimal performance for one specific temperature. Performance deteriorates with a certain amount as a function of temperature. A good example is an objective lens for an optical drive. In a typical objective lens, temperature deviations will mainly lead to spherical aberration which degrades the jitter, and thereby the readout performance. Another effect is that due to spherical aberration more laser power is required to write an effect on the disk. It is therefore very desirable to be able to control the temperature of such components.

U.S. Pat. No. 5,331,615 discloses a tracking control device apparatus for an optical disk drive device. The temperature around the tracking actuator is detected with a temperature sensor, and the characteristics of an equivalent digital filter are changed to match the characteristics of the tracking actuator at the detected temperature. When the temperature is low, a current is applied to the focus control coil to raise the temperature of the tracking actuator, thereby essentially matching the transfer functions of the tracking actuator and the equivalent filter.

A drawback of this prior art system is that the temperature is detected and controlled, thereby necessitating the requirement of a separate temperature sensor. This increases the costs of the system and also adds additional mass which may be a severe disadvantage for some systems, such as optical actuators. Furthermore, in some systems it may be difficult or even impossible to mount a temperature sensor. This is e.g. the case in small moving optical actuator or a rotating motor.

Thus, an object of the present invention is to provide a system for controlling the temperature in components, the system being cost effective and suitable for being used in e.g. small moving optical actuators and rotating motors.

A further object of the present invention is to provide a system for controlling the temperature in components without the need of a separate temperature sensor.

According to a first aspect of the present invention, the above and other objects are fulfilled by providing a system for controlling the temperature in a first electrical component, the system comprising:

means for measuring the power dissipation in said first electrical component,

means for comparing the measured power dissipation with a desired power dissipation,

means for injecting a signal into said first electrical component, in response to said comparison and in case the measured power dissipation differs from the desired power dissipation, in order to control the power dissipation in the first electrical component so as to obtain the desired power dissipation,

wherein the control of the power dissipation causes the temperature in the first electrical component to be controlled.

According to a second aspect of the present invention, the above and other objects are fulfilled by providing a method of controlling the temperature in a first electrical component, the method comprising the steps of:

measuring the power dissipation in said first electrical component,

comparing the measured power dissipation with a desired power dissipation,

injecting a signal into said first electrical component, in response to said comparison and in case the measured power dissipation differs from the desired power dissipation, in order to control the power dissipation in the first electrical component so as to obtain the desired power dissipation,

wherein the control of the power dissipation causes the temperature in the first electrical component to be controlled.

The power dissipation of the first electrical component can readily be measured without providing any additional sensor devices, such as a temperature sensor. Furthermore, the power dissipation is indicative of the temperature of the component and can therefore be used to provide a measure for the temperature. Consequently, controlling the power dissipation will also result in control of the temperature in the first electrical component. The environmental temperature will of course also influence the temperature of the first electrical component. However, this temperature normally does not vary significantly at the relevant time scales, and the primary contributions to temperature changes in the first electrical component are therefore eliminated, or at least significantly reduced, by the present invention.

It is a great advantage that the temperature of the first component is controlled by means of measuring and controlling the power dissipation, i.e. without the need for a separate temperature sensor, because the costs and additional mass involved with providing a separate temperature sensor are avoided.

In particular for optical actuators it is a severe disadvantage that the mass is increased. An increased mass causes a drop in efficiency, i.e. the required movement (e.g. to track a disk) will lead to more power dissipation in the actuator as well as in the actuator driver IC, thereby causing an increase in temperature of the system. An increased mass also generally reduces the obtainable bandwidth. This is also a disadvantage since high bandwidth is a very strong requirement for optical actuators.

There are further disadvantages involved with providing a separate temperature sensor for controlling the temperature. A temperature sensor on the moving part of an actuator needs to be connected via additional wires to non-moving parts of the system. This might lead to robustness problems, and the wires may break after many hours of operation. Furthermore, connecting such wires may be a very cumbersome process, and it may therefore increase the costs of the system considerably.

Furthermore, the power dissipation can, when using the present invention, be measured directly on the component, i.e. it can be measured even on a component onto which it is difficult or even impossible to mount a separate temperature sensor, e.g. on small moving optical actuators or rotating motors.

The first electrical component may e.g. be a coil, such as an actuator coil of an optical actuator, e.g. a focus coil (for providing a focus movement) or a radial coil (for providing a radial movement). Alternatively it may be a linear motor, or any other suitable electrical component positioned, e.g., in a wafer stepper, a milling machine or a camera.

The means for measuring the power dissipation may e.g. comprise one or more prior art controllers required to control the position of an optical actuator. (Generally two such controllers are present, one for focus position and one for radial position control.) Such controller(s) may be implemented in a digital signal processor (DSP), but may alternatively be implemented in hardware. The controller(s) calculate(s) the signal(s) (generally a voltage or a current) required to make the actuator track the disk. This voltage will lead to power dissipation in the coils. By squaring the signal which is fed to the actuator a measure for the power dissipation is calculated. The squaring operation may be a measurement circuit for power (P=U²/R, where R is a constant corresponding to the coil resistance). This circuit may be a ‘new’ circuit, i.e. a circuit implemented in the system for this specific purpose. Alternatively, it may already be present in the system for some other purpose. The measurement signal is compared, and the result is fed into a second controller (i.e. not one of the controllers mentioned above) which controls the dissipation. The output of the second controller is connected to the injecting means. The second controller and/or the injection means may advantageously be implemented in a DSP, but they may alternatively be implemented directly into hardware.

The comparing means may comprise circuitry, e.g. implemented on a DSP as described above. Preferably, the comparing may be a simple subtraction of signals performed by a DSP.

The desired power dissipation may be an essentially fixed value, e.g. a value which is indicative of or corresponding to the optimal operation temperature or a preferred temperature range for the first electrical component. In this case the present invention may be used for maintaining the temperature of the first electrical component at an optimal temperature, or at least within a certain range around the optimal temperature.

Alternatively, it may be a value which is variable according to the present operational conditions or needs. For example, when an optical drive is about to perform a recording on an optical disk, an optimum power control (OPC) procedure is performed in order to determine the optimum writing power. However, in case the recording is to be performed shortly after the optical drive has been powered, the temperature at which the OPC procedure is performed will not be representative for the temperature of the actuator and the laser during the recording, because the temperature of these components will inevitably increase during the recording due to the power supplied to the actuator. Therefore, the OPC procedure is performed at a temperature which is relatively low, and the found optimum power may consequently not be representative for the recording. In order to rapidly increase the temperature of the component the desired power dissipation may be set at a relatively high value corresponding to a relatively high temperature. Thus, according to the present invention, the temperature of the component may be rapidly increased before the OPC procedure is performed, thereby obtaining an optimum power which is more representative for the recording. Thereby transient effects may be reduced.

Alternatively or additionally, the desired power dissipation may be dependent on the ambient temperature.

The injected signal is supplied to the first electrical component together with the original signal, thereby increasing the total energy of the signal.

In a preferred embodiment the injected signal has a signal energy which is outside the region of normal operation of the first electrical component. In this case the injected signal causes minimal disturbance to the first electrical component. Thereby the temperature control may be performed even while the component is operating. This is a great advantage since a complete stop of the system in which the first electrical component is positioned is avoided, thereby making the operation of the system more smooth. Furthermore, a complete stop causes an undesirable drop in performance. Thus, stopping the drive during recording in order to ‘warm up’ one or more components will result in longer recording times. It is, thus, highly undesirable to stop the ‘normal function’ of a device in order to control the temperature of a component. Finally, the wear on various components due to start/stop of the operation is avoided.

The system may further comprise at least a second component positioned in the vicinity of the first electrical component, in which case the control of the temperature in the first electrical component in turn causes the temperature in the second component to be controlled. In this embodiment the temperature of another component, which is not necessarily an electrical component, may be controlled by controlling the temperature of an electrical component positioned in the vicinity.

The second component may be an electrical component, such as described above, or it may be an optical component, such as a lens, e.g. a blu-ray/DVD/CD compatible objective lens, a servo lens, a collimator lens or a beamshaper. Alternatively, it may be a mechanical component or any other suitable kind of component.

The system may further comprise one or more additional electrical components positioned in the vicinity of the second component, said additional electrical component(s) being adapted to have the power dissipation in it/them controlled in the same manner as the first electrical component, so as to balance the temperature of the second component.

In this embodiment the temperature gradient across the second component can be controlled by controlling the power dissipation, and thereby the temperature, of each of the electrical components positioned in the vicinity of the second component. This embodiment is particularly useful in a 3D actuator carrying a blu-ray drive compatible objective lens. The lens is in this case surrounded by two focus coils which can be alternately powered to balance the temperature surrounding the lens.

In order to further minimize the disturbance to the first electrical component, the injected signal may be a noise signal, such as a white noise signal. Alternatively or additionally, a high pass filter having an appropriate cut-off frequency may be added.

The system of the present invention may advantageously form part of an optical disk drive.

These and other aspects of the invention will be apparent from and elucidated with reference to the embodiments described hereinafter.

The invention will now be described with reference to the accompanying drawings in which

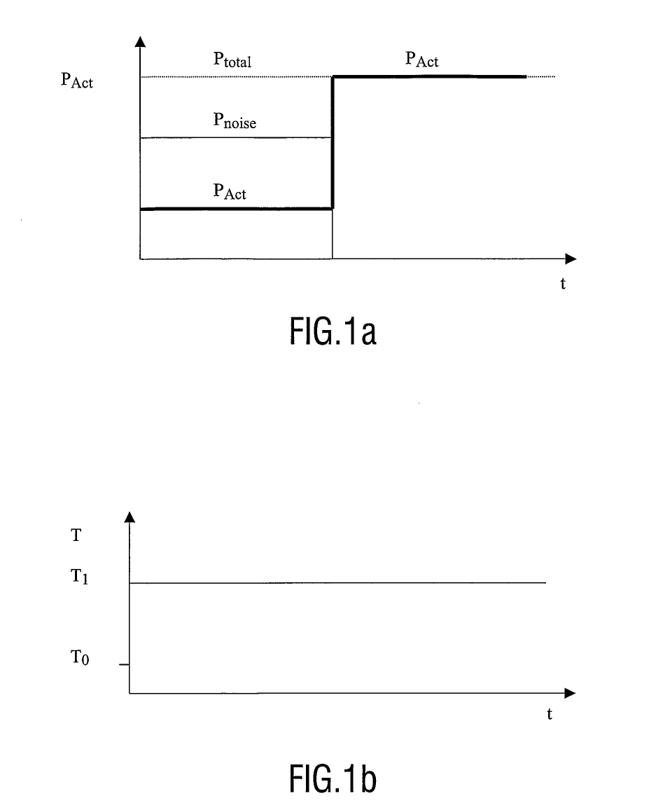

FIG. 1a shows the power dissipation in an actuator during read of a nominal and a bad disk when additional noise is added to the actuator coil system,

FIG. 1b shows the steady state temperature corresponding to the situation in FIG. 1a,

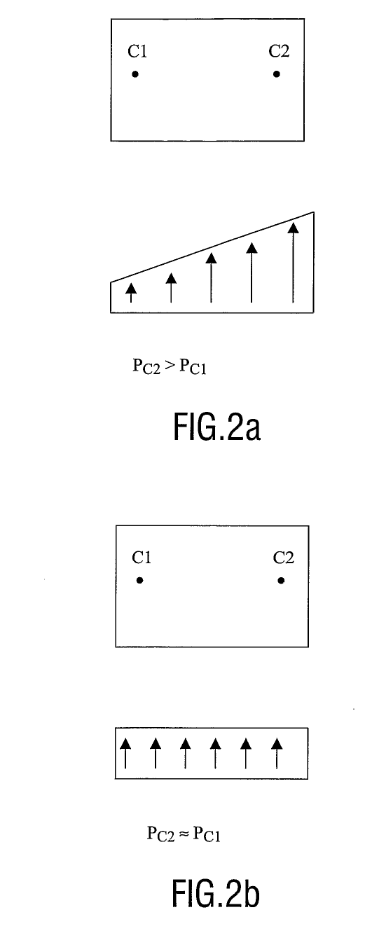

FIGS. 2a and 2b show steady state temperature gradients in a component, such as an actuator, for different power distributions,

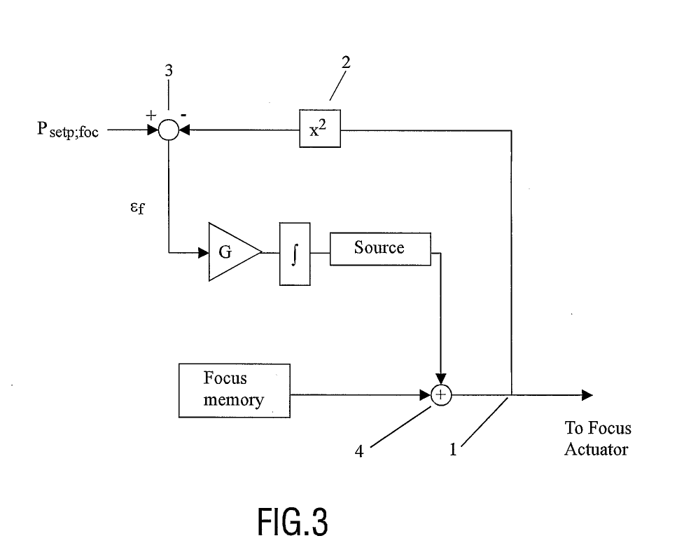

FIG. 3 shows one example of a power control loop, and

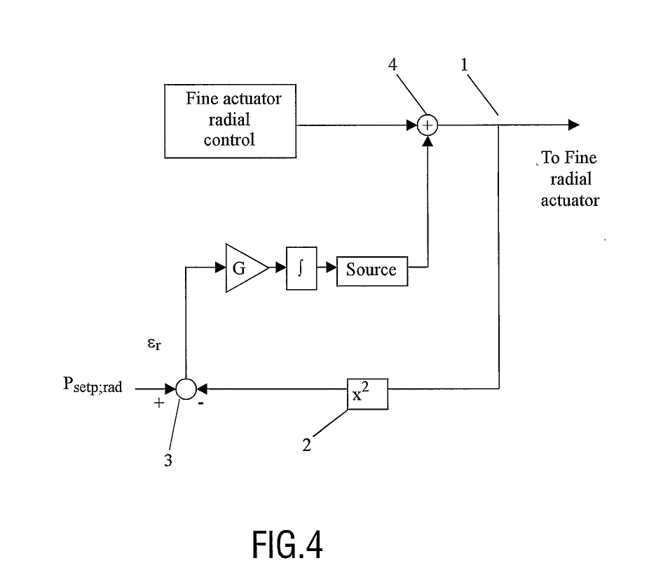

FIG. 4 shows another example of a power control loop.

FIG. 1 shows the power dissipation (FIG. 1a) and steady state temperature (FIG. 1b) of an actuator coil as a function of time, t. As can be seen from FIG. 1a a noise signal causing a power dissipation, Pₙₒᵢₛₑ, is injected into the actuator when the actuator power dissipation, P_{Act}, is relatively low, e.g. when a ‘nominal disk’ is being read. The noise signal is configured in such a way that the total power dissipation in the actuator, Pₜₒₜₐₗ, corresponds to the actuator power dissipation of an actuator during read of a ‘bad disk’. As can be seen from FIG. 1b this has the effect that the temperature of the actuator is kept substantially constant independently of the actuator power dissipation.

In the above, a ‘nominal disk’ is to be understood as a disk which is very flat and has small disturbances, e.g. low eccentricity. As a result, only small actuator movements are required to track the disk, resulting in a low power dissipation. On the other hand, a ‘bad disk’ is to be understood as a disk which is not flat, and has a relatively high eccentricity. As a result, relatively large movements are required to track the disk, resulting in a high power dissipation.

FIG. 2a shows the steady state temperature gradient in a component with a non-symmetrical power spread across the component. C1 and C2 represent two dissipating elements, e.g. two coils. As can be seen, the power at C2 is larger than the power at C1 (P_{C2}>P_{C1}), resulting in a temperature gradient across the component illustrated by the arrows which schematically represent the temperature at various points across the component. By means of the present invention, the power dissipation of C1 and C2 can be controlled in such a way that the temperature distribution is made more flat across the component, i.e. avoiding or at least reducing gradient effects.

FIG. 2b shows the steady state temperature gradient in a component with a substantially symmetrical power spread across the component, i.e. the power at C1 is approximately the same as the power at C2. As can be seen, this results in a substantially equal temperature distribution across the component as illustrated by the arrows having approximately the same length. Thereby non-symmetrical deformation of the component is minimized.

The component shown in FIGS. 2a and 2b may preferably be an actuator.

FIG. 3 shows a power control loop for a focus coil. The signal sent to the focus actuator is measured at 1 and squared at 2. The squared signal is subsequently compared to a desired power dissipation, P_{setp;foc}, at 3 resulting in an error signal, ε_{f}. This error signal is fed into an amplifier G and an integrator, and the resulting signal is fed to a source, preferably a noise source. The source operates in response to the received signal in such a way that if the error signal indicates that the measured power dissipation is different from the desired power dissipation, then an appropriate signal is generated for injection into the actuator. If, on the other hand, the error signal indicates that the measured power dissipation and the desired power dissipation are at least substantially identical, no signal will be generated. The generated signal, if any, is added to a signal from the focus memory at 4 in order to control the power dissipation, and the resulting signal is fed to the focus actuator coil. The resulting signal is also clamped at 1, and the procedure described above is thereby repeated. As a result the power dissipation in the coil will be constant, even if the actuator control signals direct the actuator in focus direction.

FIG. 4 shows a power control loop similar to the loop of FIG. 3. However, this loop is for a fine radial actuator. Apart from that the loop works in the same way as the loop described above and like features are provided with like reference numerals.

It should be noted that each coil of an actuator can be provided with a loop as described above. Thus, e.g. in a 3D actuator having two focus coils or a focus coil and a tilt coil in addition to the radial coil, there can be three loops, one for each coil.

Although the present invention has been described in connection with the preferred embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A system for controlling the temperature in a first electrical component, the system comprising:
means (1) for measuring the power dissipation in said first electrical component,
means (3) for comparing the measured power dissipation with a desired power dissipation,
means (4) for injecting a signal into said first electrical component, in response to said comparison and in case the measured power dissipation differs from the desired power dissipation, in order to control the power dissipation in the first electrical component so as to obtain the desired power dissipation,
wherein the control of the power dissipation causes the temperature in the first electrical component to be controlled.

2. A system according to claim 1, wherein the injected signal has a signal energy which is outside the region of normal operation of the first electrical component.

3. A system according to claim 1, further comprising at least a second component positioned in the vicinity of the first electrical component, wherein the control of the temperature in the first electrical component in turn causes the temperature in the second component to be controlled.

4. A system according to claim 3, wherein the second component is an electrical component.

5. A system according to claim 3, wherein the second component is an optical component.

6. A system according to claim 3, further comprising one or more additional electrical components positioned in the vicinity of the second component, said additional electrical component(s) being adapted to have the power dissipation in it/them controlled in the same manner as the first electrical component, so as to balance the temperature of the second component.

7. A system according to claim 1, wherein the desired power dissipation is an essentially fixed value which is indicative of a preferred temperature range for operation of the first component.

8. A system according to claim 1, wherein the injected signal is a noise signal.

9. An optical disk drive comprising a system according to claim 1.

10. A method of controlling the temperature in a first electrical component, the method comprising the steps of:
measuring the power dissipation in said first electrical component,
comparing the measured power dissipation with a desired power dissipation,
injecting a signal into said first electrical component, in response to said comparison and in case the measured power dissipation differs from the desired power dissipation, in order to control the power dissipation in the first electrical component so as to obtain the desired power dissipation,
wherein the control of the power dissipation causes the temperature in the first electrical component to be controlled.
